(19) United States
(12) Patent Application Publication
(10) Pub. No.: US 2026/0017558 A1
(43) Pub. Date: Jan. 15, 2026

(54) GENERATING PROPENSITY MODELS USING NATURAL LANGUAGE STATEMENTS

(71) Applicant: Adobe Inc., San Jose, CA (US)

(72) Inventors: Eugene Y. Chen, San Jose, CA (US); Yi-Hong Kuo, Belmont, CA (US); Shrevas Subramanya, San Jose, CA (US)

(73) Assignee: Adobe Inc., San Jose, CA (US)

(21) Appl. No.: 18/770,038

(22) Filed: Jul. 11, 2024

(51) Int. Cl. G06N 20/00

(52) U.S. Cl. CPC G06N 20/00

(57) ABSTRACT

A user interface (UI) module receives natural language input for generating a machine learning (ML) model. A large language model (LLM) determines, based on the natural language input, a prediction goal for the ML model. The LLM accesses dataset metadata to identify a dataset and column metadata to identify a data column in the dataset. The LLM generates a model configuration for the ML model according to a syntax, the model configuration including indications of the prediction goal, the dataset, and the data column.

### BACKGROUND

Automated machine learning (AutoML) solutions are used to create machine learning (ML) models for users. The users may provide input to create the models via one or more graphical user interfaces (GUIs). However, such solutions require knowledge of the underlying data and the GUIs. For example, these solutions may require that users select specific data repositories, data tables, and/or specific data columns as a prerequisite to automated ML generation. For example, some users may find it challenging to select the correct datasets, identify objectives, or specify other parameters for automated ML generation. Therefore, users without the required knowledge or a technical background may have difficulty using these automated ML solutions.

### SUMMARY

Embodiments are generally directed to solutions for automated ML generation. More specifically, embodiments disclosed herein leverage one or more large language models (LLMs) to facilitate automated ML generation. The LLMs are configured to receive natural language input from users that specifies the objectives for the model. The LLMs use the natural language input and metadata associated with data in a plurality of datasets to generate model configuration information that represents the desired ML output. The model configuration information is then used to automatically generate the ML model for the user.

Any of the above embodiments may be implemented as instructions stored on a non-transitory computer-readable storage medium and/or embodied as an apparatus with a memory and a processor configured to perform the actions described above. It is contemplated that these embodiments may be deployed individually to achieve improvements in resource requirements and library construction time. Alternatively, any of the embodiments may be used in combination with each other in order to achieve synergistic effects, some of which are noted above and elsewhere herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 3A illustrates an aspect of the subject matter in accordance with one embodiment.

FIG. 3B illustrates an aspect of the subject matter in accordance with one embodiment.

FIG. 3C illustrates an aspect of the subject matter in accordance with one embodiment.

FIG. 4 illustrates an aspect of the subject matter in accordance with one embodiment.

FIG. 5 illustrates a system 500 in accordance with one embodiment.

FIG. 6 illustrates an apparatus 600 in accordance with one embodiment.

FIG. 7 illustrates an artificial intelligence architecture 700 in accordance with one embodiment.

FIG. 8 illustrates an artificial neural network 800 in accordance with one embodiment.

FIG. 9 illustrates a system 900 in accordance with one embodiment.

FIG. 10 illustrates an aspect of the subject matter in accordance with one embodiment.

FIG. 11 illustrates a logic flow 1100 in accordance with one embodiment.

FIG. 12 illustrates a logic flow 1200 in accordance with one embodiment.

FIG. 13 illustrates a computing architecture 1300 in accordance with one embodiment.

### DETAILED DESCRIPTION

Exemplary embodiments are generally directed to techniques for automated construction of ML models using natural language statements provided by users. Generally, embodiments disclosed herein enrich various datasets with metadata that is used by artificial intelligence (AI) and/or ML components such as LLMs to create model configurations that are in a predetermined syntax and/or expression used by automated ML platforms, such as a model generation module. The model configurations are used by the automated ML platforms to create ML models for the users. In some embodiments, the metadata defines various properties of the datasets (and/or the underlying data itself), such as aliases, business contexts, and permitted values for each data column in a given dataset. In some embodiments, retrieval-augmented generation (RAG) is used to embed pertinent metadata into a prompt and apply a chain-of-thought technique to efficiently translate natural language into a precise language used by the automated ML platform to create ML models. In some embodiments, multiple GUI paradigms are used to compel system users to parse their input, thereby allowing smaller LLMs to efficiently complete tasks that otherwise require larger LLMs for processing.

In one example, a user desires to create a model that predicts whether users from the United States will buy light blue shoes. However, the user has minimal understanding of the various datasets that store the data that can be used to create the model. Advantageously, embodiments disclosed herein permit the user to instruct the model generation module to the create the model by providing natural language input to a user interface (UI) module. The user input may be any natural language input such as “predict US users who will buy light blue shoes”. In some embodiments, a prompt module automatically identifies the relevant datasets that store relevant data based on the natural language input and metadata associated with the datasets. Similarly, in some embodiments, the prompt module automatically identifies specific columns in each identified dataset that store relevant data. The prompt module may complete one or more prompt templates using the identified data. The prompt module may provide the completed templates to the LLM as part of the chain-of-thought process to instruct the LLM to create the model configuration. Further still, the LLM uses the templates, identified datasets, and the columns to create the model configuration in a specific syntax used by the model generation module to create the model. The generated model configuration information further includes other attributes describing the desired model, such as a name for the model, a type of the model, etc. Embodiments are not limited in these contexts.

In some environments, hundreds, thousands, or more datasets are available to create models. Similarly, a given dataset has hundreds, thousands, or more data columns. Each dataset and data column has a specific configuration, e.g., names, ID types, key fields, possible values, etc. Therefore, it is impractical or impossible for users to have a comprehensive understanding of the datasets and/or data columns. By allowing users to provide natural language input and generating the correct information required to create a model (e.g., specific data sets, data columns, operators, possible values, etc.), embodiments disclosed herein allow any user to create ML models without understanding the datasets, data columns, and/or the configuration thereof.

### Term Definitions:

As used herein, the term “model generation module” refers to a module that simplifies the process of developing machine learning models by automating many of the tasks that typically require specialized knowledge. In some embodiments, the model generation module automatically creates ML models using model configuration information that is in a specific syntax and/or expression.

As used herein, the term “prediction goal” refers to an objective that specifies a desired outcome or event that a model such as a propensity model aims to forecast. A prediction goal includes one or more specific events to be predicted, the entity or subject of the prediction, and/or the timeline in which the event will occur. A prediction goal guides the development, training, and application of the predictive model, ensuring the model delivers actionable insights aligned with organizational or research objectives.

As used herein, the term “propensity model” refers to a predictive model used to estimate the likelihood that a specific event or behavior will occur for a given entity, based on historical data and various input features. Propensity models analyze patterns and relationships within the data to assign a probability score to each entity, indicating the chances of the target event happening.

As used herein, the term “prompt module” refers to a module designed to fill and complete prompt templates for LLMs. In some embodiments, the prompt module leverages metadata associated with datasets and data in the datasets to fill and complete the prompt templates. The prompt module includes features to select templates from a library of templates, extract parameters from natural language input, populate the template with the extracted parameters, and provide the populated template to an LLM. In some embodiments, the prompt module is an LLM.

As used herein, the term “user interface (UI) module” refers a component that provides a visual interface that allows users to interact with electronic devices, software applications, and operating systems through graphical elements such as icons, buttons, menus, and windows.

As used herein, the term “dataset metadata” refers to information that describes the various aspects of one or more datasets, providing context and details for understanding, managing, and utilizing the data effectively. Dataset metadata includes a descriptive summary of the structural, administrative, and/or contextual information about the dataset.

As used herein, the term “column metadata” refers to information that describes and provides context about one or more columns within a dataset. Column metadata describes the nature, type, purpose, and/or constraints of the data contained in that column, facilitating use and interpretation.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

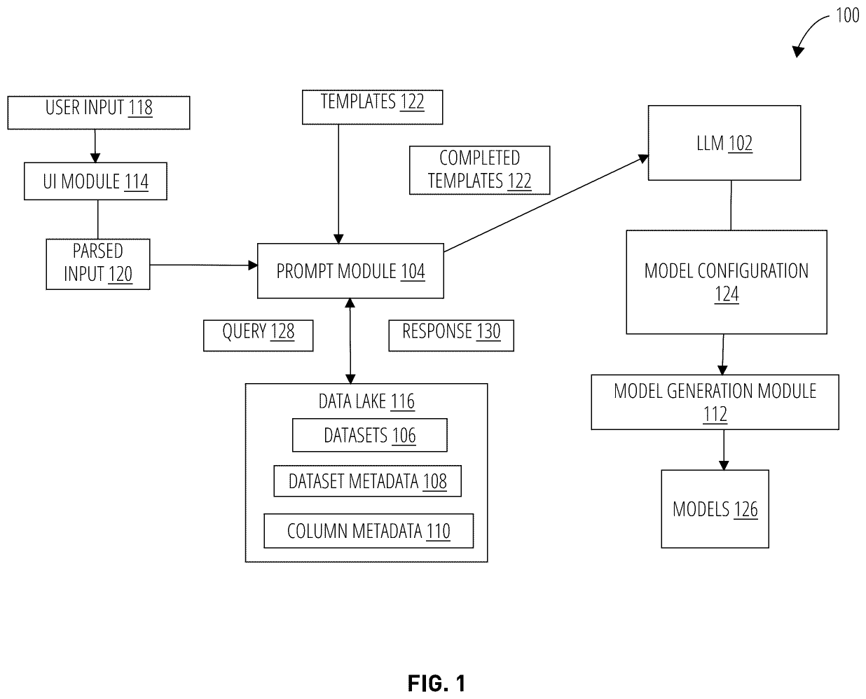

FIG. 1 illustrates an embodiment of a system 100. The system 100 is suitable for implementing one or more embodiments as described herein. In one embodiment, for example, the system 100 is an automated ML system suitable for generating models such as propensity models using natural language statements.

As shown, the system 100 includes one or more UI modules 114, one or more prompt modules 104, one or more LLMs 102, and one or more model generation modules 112. The UI modules 114, prompt modules 104, LLMs 102, and model generation modules 112 may be implemented in computer hardware, computer software, or a combination thereof. In some embodiments, the prompt modules 104 are implemented as one or more LLMs. The model generation module 112 is an automated ML platform to create ML models. One example of an automated ML platform is the Customer AI (CAI) service of the Adobe® Experience Platform (AEP).

The UI module 114 presents one or more interfaces to users, where the interfaces are configured to receive and process input for generating ML models such as the models 126. The models 126 may be any type of ML model, including but not limited to propensity models. The UI module 114 presents any number and type of user interfaces, such as form-based interfaces, chatbot interfaces, etc. In some embodiments, the UI module 114 is configured to receive natural language input 118 from a user, where the natural language input 118 specifies to create a ML model for a prediction goal. One example of a prediction goal is to “identify users from Japan who will purchase Acrobat using the US dollar in the next week.” In some embodiments, the model generation module 112 operates on specific syntax and/or expressions. Embodiments are not limited in these contexts.

Furthermore, data in one or more datasets 106 in one or more data lakes 116 is used by the model generation module 112 to create the requested model. For example, as shown, the data lake 116 includes a plurality of datasets 106. The datasets 106 include any number and type of datasets, such as web activity logs, purchase histories, customer databases, profile datasets, product use datasets, analytics datasets, etc. The datasets 106 may be stored in any suitable structure, such as databases, files, key-value stores, etc. However, knowledge of the data in a given dataset 106 is often required to create a model 126 using the model generation module 112, e.g., to provide input in a format that can be used by the model generation module 112 to create the model. For example, the user may be required to know where particular data tables are stored, which data columns include specific data, where columns store identity information, what values the data column can hold, etc.

However, the system 100 does not impose such requirements on users, as the system 100 allows users to generate models using natural language statements such as the input 118. For example, the UI module 114 parses the input 118 to create parsed input 120. The UI module 114 parses the input 118 according to any number and type of parsing functions. The UI module 114 provides the parsed input 120 to one or more prompt modules 104. The prompt modules 104 generate a query 128 based on the parsed input 120. The query 128 is executed against the dataset metadata 108 and the column metadata 110 to return a response 130 including at least a portion of dataset metadata 108 and/or column metadata 110. The prompt module 104 uses the information in the response 130 to complete one or more prompt templates 122 also referred to as “prompt templates”).

The dataset metadata 108 is representative of any number and type of metadata attributes for an associated dataset. In some embodiments, the dataset metadata 108 encapsulates the business context of each of the datasets 106 and identifies the user types to which the dataset is applicable. The column metadata 110 is representative of any number and type of metadata attributes for an associated data column in a dataset. In some embodiments, the column metadata 110 encapsulates the common name, description, possible values, and business context for each column in the dataset 106.

Therefore, using the dataset metadata 108 and the column metadata 110, the prompt modules 104 select one or more of the datasets 106 and one or data columns in the one or more datasets 106 that stores the data to generate the requested model. Embodiments are not limited in these contexts, as the prompt module prompt modules 104 are configured to identify any number and type of datasets 106, data columns, data types, data values, etc., to complete a template 122.

The prompt modules 104 provide the completed one or more templates 122 to the LLM 102 to cause the LLM 102 to create a model configuration 124 for the predictive model requested by the user via the input 118. Generally, the templates 122 are pre-designed structures or formats used to guide the generation of text responses by the LLM 102. These templates 122 allow the LLM 102 to provide more accurate, coherent, and contextually relevant outputs. The templates 122 frame the input in a way that maximizes the likelihood of receiving the desired output. The model configuration 124 generally includes data or instructions for training and/or otherwise creating the model by the model generation module 112. The model configuration 124 is in a syntax and/or expression required by the model generation module 112.

For example, the templates 122 include static configuration information and variable (or dynamic) fields that can be populated using the dataset metadata 108 and/or the data column metadata 110. For example, one or more of the prompt modules 104 use the parsed natural language input to identify relevant datasets 106 based on the dataset metadata 108. The dataset metadata 108 includes metadata describing each of the datasets 106. The column metadata 110 includes metadata describing one or more columns of the datasets 106.

Although depicted as parts of a single data lake 116, in some embodiments, the datasets 106 are included in multiple distinct data lakes 116. Similarly, in some embodiments, the dataset metadata 108 is implemented in one or more distinct databases (e.g., separate from the datasets 106 and/or the column metadata 110). Similarly, in some embodiments, the column metadata 110 is implemented in one or more distinct databases (e.g., separate from the datasets 106 and/or the dataset metadata 108). In some embodiments, the column metadata 110 and the dataset metadata 108 are provided as service resources. In some embodiments, values for the dataset metadata 108 and the column metadata 110 are provided by users.

In some embodiments, the column metadata 110 and/or the dataset metadata 108 are vector databases. In such examples, a vector (or embedding) is a key in the column metadata 110 and/or dataset metadata 108 and the corresponding value includes the associated metadata. Doing so is advantageous as synonyms of the same term may result in the same embedding (e.g., the embeddings of “acro”, “acrobat” and “pdf software” may the same or similar). Doing so reduces the need to enumerate each possible term in the column metadata 110 or the dataset metadata 108. Therefore, in such embodiments, the query 128 includes an embedding computed by the prompt module 104 based on the parsed input 120. The prompt module 104 uses any suitable embedding function to compute the embedding.

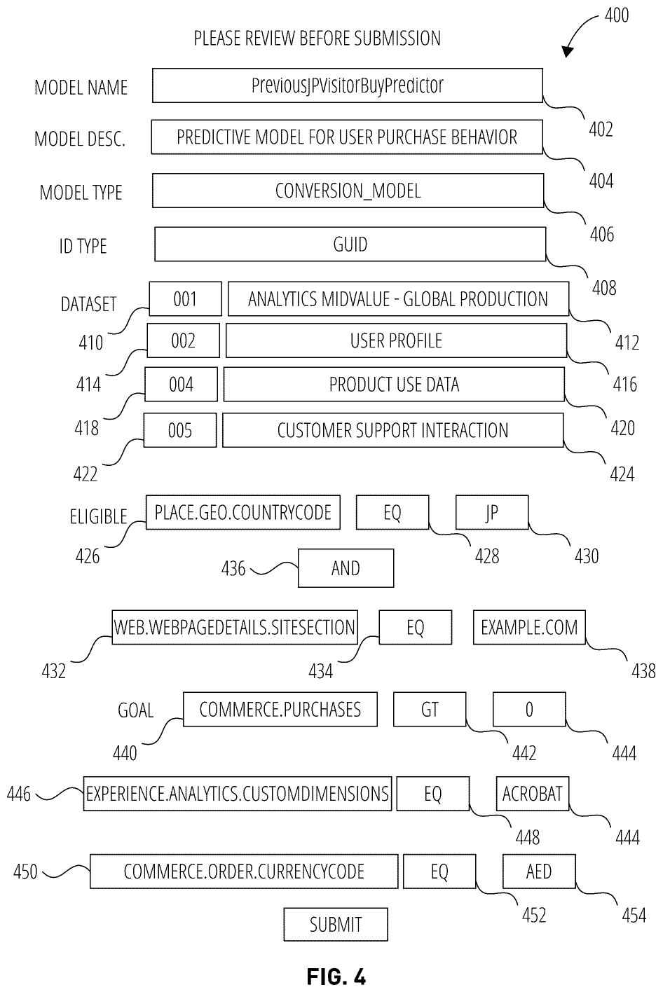

In some embodiments, the templates 122 include respective JSON files with descriptions of the dataset metadata 108 and column metadata 110. The one or more prompt modules 104 further use the column metadata 110 to identify one or more data columns in the one or more datasets 106. The one or more prompt modules 104 further generate descriptive metadata for the model 126 to be created. As stated, the prompt modules 104 fill in the variable metadata into the one or more templates 122. Doing so allows the LLMs 102 to create a model configuration 124 based on the templates 122. The data displayed in FIG. 4 is representative of an example of the model configuration 124. In some embodiments, the model configuration 124 is stored as a JSON file.

In some embodiments, the dataset metadata 108 and the column metadata 110 for a given request are fed into the LLM 102 as part of a chain-of-thought (CoT) prompt. In some embodiments, the CoT prompt is performed using one or more of the templates 122. Using CoT prompt templates 122 allows the LLMs 102 to transform the prediction objective and suitable conditions into a sequence of logical expressions that can be applied to the machine learning dataset, e.g., as part of a model configuration 124.

As stated, the model generation module 112 operates on one or more restrictive syntaxes and/or expressions. Advantageously, the logical expressions created by the LLMs 102 translate the natural language input into the correct syntaxes and/or expressions. Doing so allows models to be created without knowledge of the datasets 106 and components thereof. This is useful when the natural language input includes typos, non-standard language, or irrelevant information.

The LLMs 102 are able to associate a column's name with its business context and link a standard product's name with the product's functionality. Furthermore, the LLMs 102 are able to identify irrelevant requests. For example, a natural language goal of “buy kryptonite” returns a null statement or error, as this is not a valid prediction goal for the client who uses the system.

The model configuration 124 is returned to the user by the UI module 114 for approval (e.g., via the interface 400 of FIG. 4). The user may then submit the job for model creation by the model generation module 112. The model configuration 124 is used by the model generation module 112 to create (e.g., train, test, and/or validate) one or more models 126 as responsive to the user's natural language request. In some embodiments, the model generation module 112 exposes one or more APIs to receive the model configuration 124 and initiate generation of the models 126. The models 126 include propensity models, churn models, conversion models, or any type of model. For example, conversion models identify users who will make a purchase or perform some other event, while churn models identify users who will cancel a certain service, refrain from renewing a subscription, etc. The models 126 are executed according to the parameters specified in the model configuration 124. For example, the models 126 are executed to identify target populations of users who will purchase a product, not renew a subscription, etc. Embodiments are not limited in these contexts.

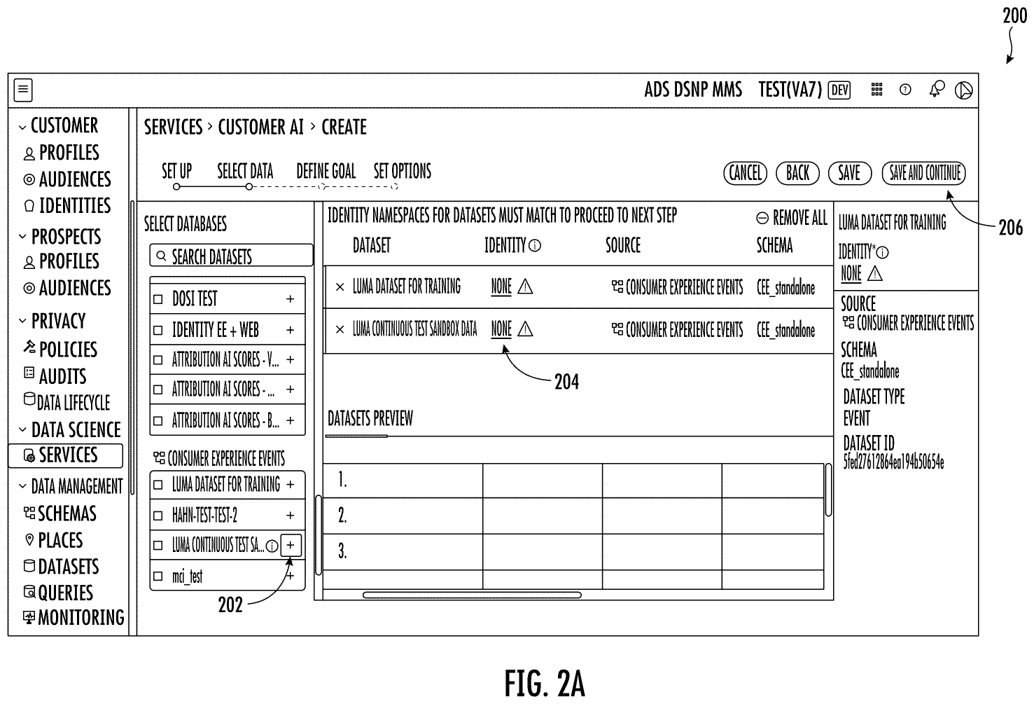

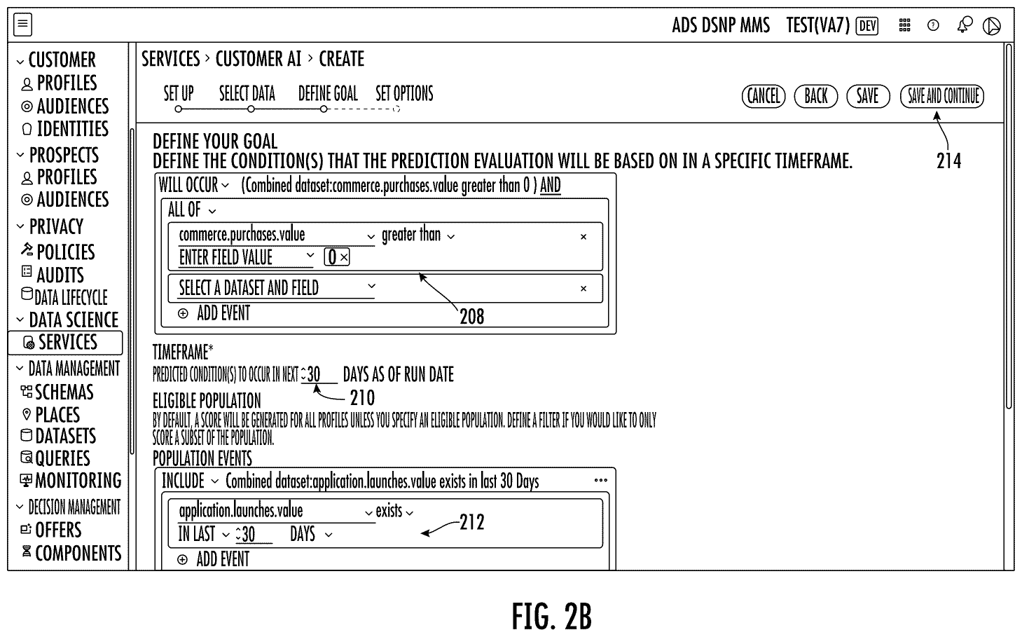

FIG. 2A illustrates a user interface 200. The user interface 200 is representative of a conventional user interface to create ML models. The user interface 200 may be included in a conventional automated ML platform to create ML models. Embodiments are not limited in this context.

Conventionally, to create a ML model, a user must provide input via the user interface 200. A subset of the operations performed to provide input are depicted in FIGS. 2A-2B. Some of the operations not depicted include providing a name for the model, a description of the model, a type of the model (e.g., a conversion model, a churn model, etc.), etc. Furthermore, the user must specify one or more datasets from a plurality of datasets for use in creating the model. For example, as shown at 202, the user may select one or more datasets from a plurality of listed datasets. Once selected, the user must specify one or more columns of the selected dataset as including an identity column (e.g., a customer identifier column, a unique key, etc.) at 204. For example, the user may type in the name of the identity column, select the identity column from a dropdown list of columns in the selected dataset, etc. The user may then save and continue at 206, which causes the user interface 200 to proceed to the screen depicted in FIG. 2B.

As shown in FIG. 2B, to create a model, the user must further specify one or more prediction goals at 208. For example, the prediction goal is predicting whether a customer will make one or more purchases. However, as shown, the user must specify a specific data field (e.g., dataset: purchases. value) from the selected datasets, an operator (e.g., greater than), and a corresponding target value (e.g., zero) for the purchase prediction. Similarly, at 210, the user must specify a timeframe for the goal (e.g., 30 days). Furthermore, at 212, the user specifies one or more constraints for eligible populations. For example, the user desiring to limit the population to users who have used an application must specify a specific data field (e.g., application.launches.value) for the selected datasets, an operator (e.g., exists), and a time window for the operator (e.g., in the last 30 days). The user then saves the progress at 214. In some embodiments, the user specifies additional parameters not depicted (e.g., timing schedules, events for exclusion, etc.). Once the parameters are specified, the user may submit the request. Doing so causes the automated ML platform to create the model based on the supplied criteria.

Therefore, the user interface 200 generally requires technical knowledge from the user. For example, the user must understand and select various datasets to create the model. However, there may be hundreds, thousands, or more datasets accessible to the user in a data lake. Similarly, the user must understand the context of each column in the selected datasets, where a given dataset may have hundreds, thousands, or more columns. Furthermore, the user may not understand the business context of each column and the possible values that can be stored in a given column. Similarly, these operations require a level of mathematical dexterity to convert a business operation into a formatted expression that can be used by the automated ML platform to create a model.

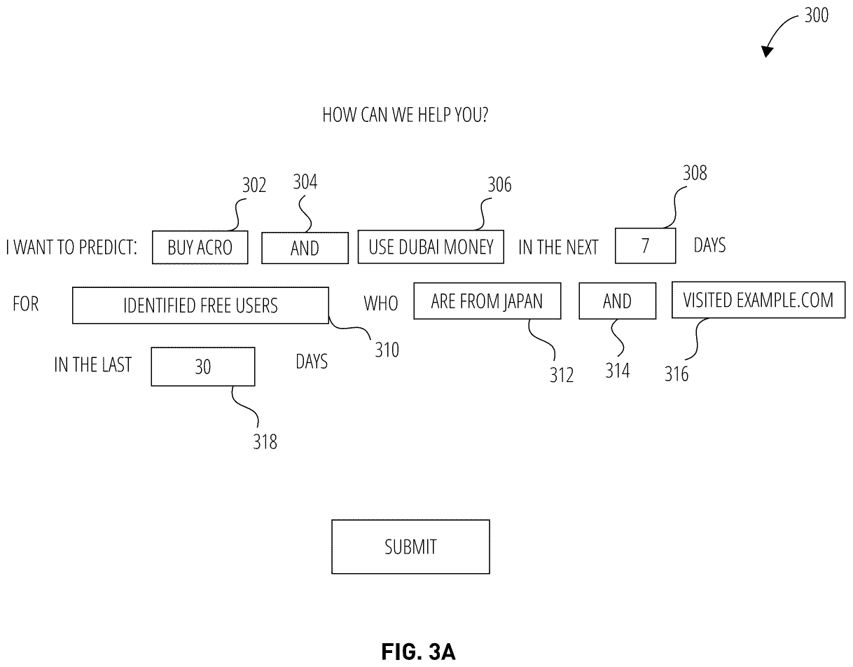

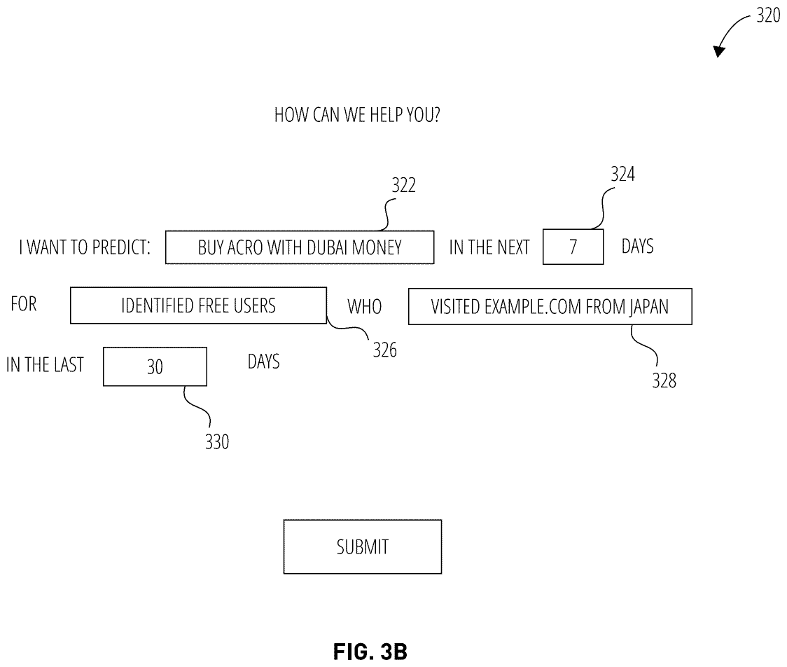

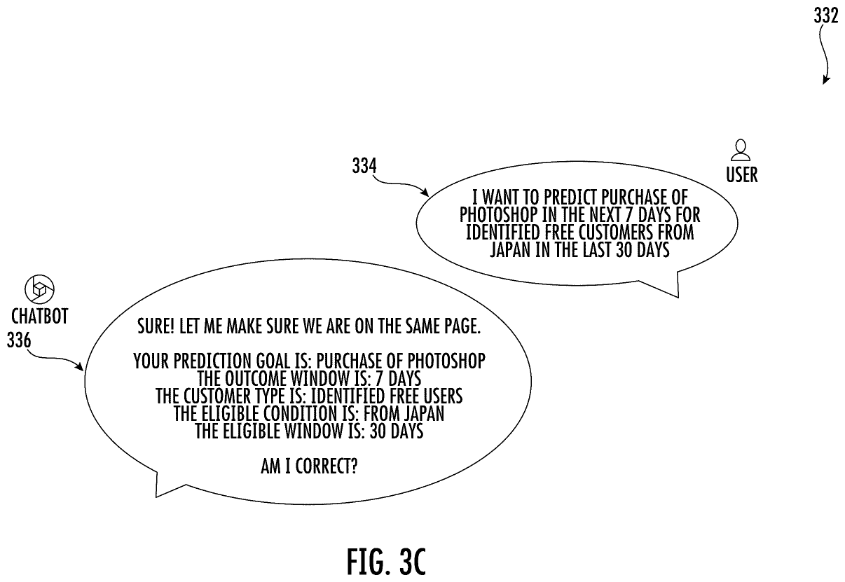

FIG. 3A depicts an example interface 300 for creating propensity models using natural language statements according to one embodiment. The interface 300 is representative of an interface provided by the UI module 114. As shown, the interface 300 includes a form with a plurality of form fields 302-318. For example, prediction field 302 is a text field that accepts natural language as input. Operator field 304 is a field that accepts an operator as input (e.g., “and”). The operator field 304 may be a text field, a drop down list, etc. The operator field 304 is used to associate a prediction field 306 with the prediction field 302.

For example, a user desires to create a model to predict users from Japan who will buy software using United Arab Emirates Dirham in the next 7 days, where these users have visited an example website in the previous 30 days. Advantageously, however, the user supplies natural language to the interface 300 to create the model. For example, as shown, the user specifies “buy acro” in prediction field 302, where “acro” is an abbreviation for a software product. Similarly, the user specifies “use Dubai money” which is natural language indicating users who will buy the software product using the Dirham. Similarly, prediction window field 308 indicates a time constraint for the prediction (e.g., 7 days).

Population field 310 indicates a constraint on the types of users, e.g., registered free users, paid users, unregistered users, etc. As shown, the user specifies “identified free users” in population field 310. In some embodiments, the population field 310 is a drop-down list that includes values extracted from metadata associated with the datasets. Constraint field 312 indicates another user constraint in natural language, e.g., that the users “are from Japan.” Operator field 314 indicates an operator to join constraint field 312 and constraint field 316, where constraint field 316 indicates the user should have visited a website (“example.com”). Constraint field 318 applies a further constraint to the users who visited the website, e.g., in the last 30 days.

The interface 300 depicted in FIG. 3A is representative of one type of interface provided by the UI module 114 for creating propensity models using natural language statements. For example, the interface 300 may have more fixed constraints relative to the interface 320 of FIG. 3B. Doing so is useful when using older versions of models having less natural language processing capabilities relative to newer versions of models.

For example, the interface 320 of FIG. 3B is presented by the UI module 114 to provide input to create a ML model using fewer fields and fewer operators than the interface 300. FIG. 3B depicts such an interface 320 for creating propensity models using natural language statements, according to one embodiment. As shown in FIG. 3B, the interface 320 includes a form with a single prediction field 322 that accepts a longer natural language statement as input. Therefore, as shown, the user specifies to create a model to predict users who will “buy acro with Dubai money” in prediction field 322. Similarly, the user specifies the 7 day time window in prediction window field 324, the identified free users in population field 326, the users who visited example.com from Japan in constraint field 328, and the 30 day constraint in constraint field 330.

Therefore, the interface 320 is more flexible than the interface 300, as the user can use more natural language statements to convey the intent without specifying operators, constraints, etc.

FIG. 3C illustrates a chatbot interface 332 provided by the UI module 114 for generating propensity models using natural language statements according to one embodiment. As shown, the user may provide a message 334 which includes the desired goals and constraints in natural language. The chatbot may reply with a message 336 which indicates the prediction goal, outcome window, customer type, eligible conditions, and the eligibility window. The chatbot interface 332 is therefore more flexible than the interfaces 300, 320, as the user requests the creation of the model using natural language.

Regardless of the interface used to provide input, embodiments disclosed herein translate the natural language input into a specific syntax (also referred to as a model configuration and/or a data definition language) used by the automated ML platform to create a ML model. In some embodiments, one or more LLMs are used translate the natural language input to the model configuration.

FIG. 4 illustrates an interface 400 with model configuration 124 generated by the LLM 102 based on natural language input provided received via the UI module 114 (e.g., via interface 300, interface 320, or chatbot interface 332). As shown, the interface 400 includes the model configuration 124 generated by the system 100 to create a ML model. For example, model name field 402 specifies a name generated by the LLM 102 for the model, model description field 404 specifies a description of the model generated by the LLM 102, model type field 406 specifies a type of the model generated by the LLM 102 (e.g., a conversion model, propensity model, etc.), and the ID type field 408 specifies the identity column identified by the LLM 102 (e.g., a unique user ID for registered users, a cookie ID for unregistered users, etc.).

The interface 400 further shows a plurality of datasets 106 (and associated identifiers) programmatically selected by the LLM 102 for the model. For example, dataset identifier 410 of a selected dataset 106 is associated with selected dataset name 412, dataset identifier 414 is associated with selected dataset name 416, dataset identifier 418 is associated with selected dataset name 420, and dataset identifier 422 is associated with dataset name 424. As stated, in some embodiments, the LLM 102 may select the datasets 106 based on the dataset metadata 108.

The interface 400 further depicts one or more criteria generated by the LLM 102 as part of the model configuration 124. For example, a first criterion indicates a data column from one or more of the datasets 106 in data column field 426, an operator in operator field 428, and a country in country field 430. Therefore, in example depicted in FIG. 4, the LLM 102 has identified a specific data column associated with user location in data column field 426, the equal operator in operator field 428, and the country code for Japan in country field 430. Therefore, the LLM 102 generated specific parameters to identify users in Japan from the datasets. As stated, in some embodiments, the LLM 102 selects the columns based on column metadata 110 associated with each data column.

The specification of “and” in field 436 indicates that a second criterion must be met along with the first criterion. As shown, the second criterion generated by the LLM 102 includes a data column from one or more of the datasets 106 in data column field 432, an operator in operator field 434, and a website in field 438. Therefore, in example depicted in FIG. 4, the LLM 102 has identified a specific data column associated with web activity in data column field 432, the equal operator in operator field 434, and the desired website in website field 438. Therefore, the LLM 102 generated specific parameters to identify users who have visited a specific website from the datasets 106.

The interface 400 further depicts a prediction goal generated by the LLM 102. For example, the prediction goal column 440 indicates a column in a dataset 106, an operator 442 for the column, and an associated value field 444. Therefore, in the example depicted in FIG. 4, the LLM 102 generated, as the prediction goal, customers who will make a purchase. The LLM 102 further generates additional constraints on the goal. For example, as shown, a constraint includes the data column field 446, operator field 448, and value field 444. In the example depicted in FIG. 4, the constraint specifies a specific data column in data column field 446, the equals operator in operator field 448, and a specific software product in value field 444. Similarly, another constraint generated by the LLM 102 includes data column field 450, operator 452, and value field 454 to indicate a currency field should equal “AED”, the standard symbol for the Dirham.

The user has the option to modify the values presented in the interface 400. Whether or not modifications are made, when the user selects the submit button, the UI module 114 makes an application programming interface (API) call to the model generation module 112 to train a model based on the model configuration 124 depicted in FIG. 4. The LLM 102 generates the model configuration 124 based on the natural language text entered in the interfaces provided by the UI module 114. More specifically, the LLM 102 creates a model configuration 124 to identify users in Japan who will purchase Acrobat® using Dirham in the next 7 days, where these users visited example.com in the previous 30 days.

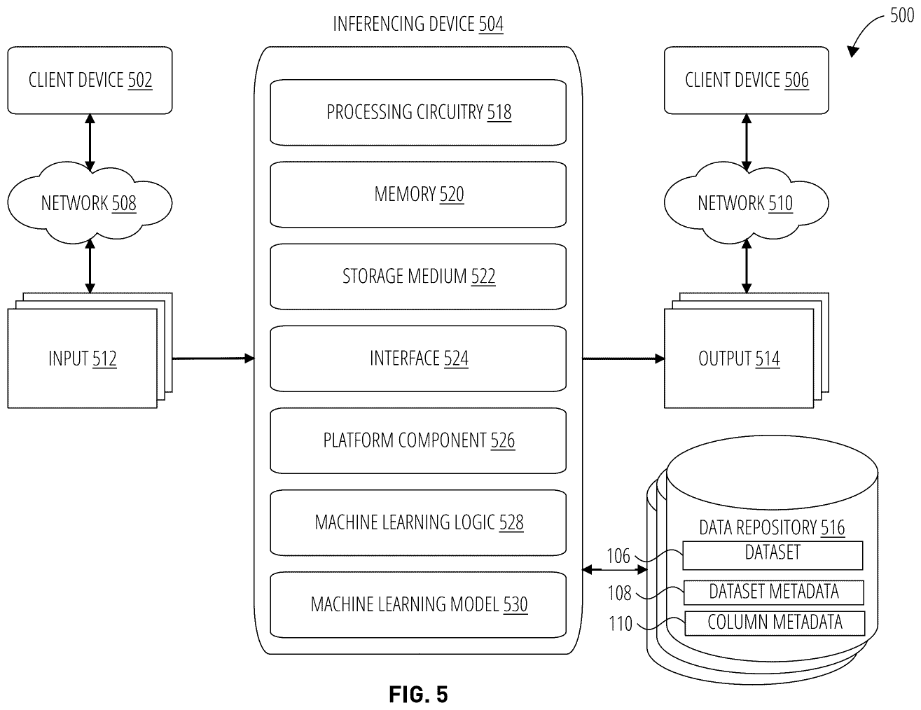

FIG. 5 illustrates an embodiment of a system 500. The system 500 is suitable for implementing one or more embodiments as described herein. In one embodiment, for example, the system 500 is an AI/ML system suitable for generating propensity models based on natural language.

The system 500 comprises a set of M devices, where M is any positive integer. FIG. 5 depicts three devices (M=3), including a client device 502, an inferencing device 504, and a client device 506. The inferencing device 504 communicates information with the client device 502 and the client device 506 over a network 508 and a network 510, respectively. The information may include input 512 from the client device 502 and output 514 to the client device 506, or vice-versa. In one alternative, the input 512 and the output 514 are communicated between the same client device 502 or client device 506. In another alternative, the input 512 and the output 514 are stored in a data repository 516. In yet another alternative, the input 512 and the output 514 are communicated via a platform component 526 of the inferencing device 504, such as an input/output (I/O) device (e.g., a touchscreen, a microphone, a speaker, etc.).

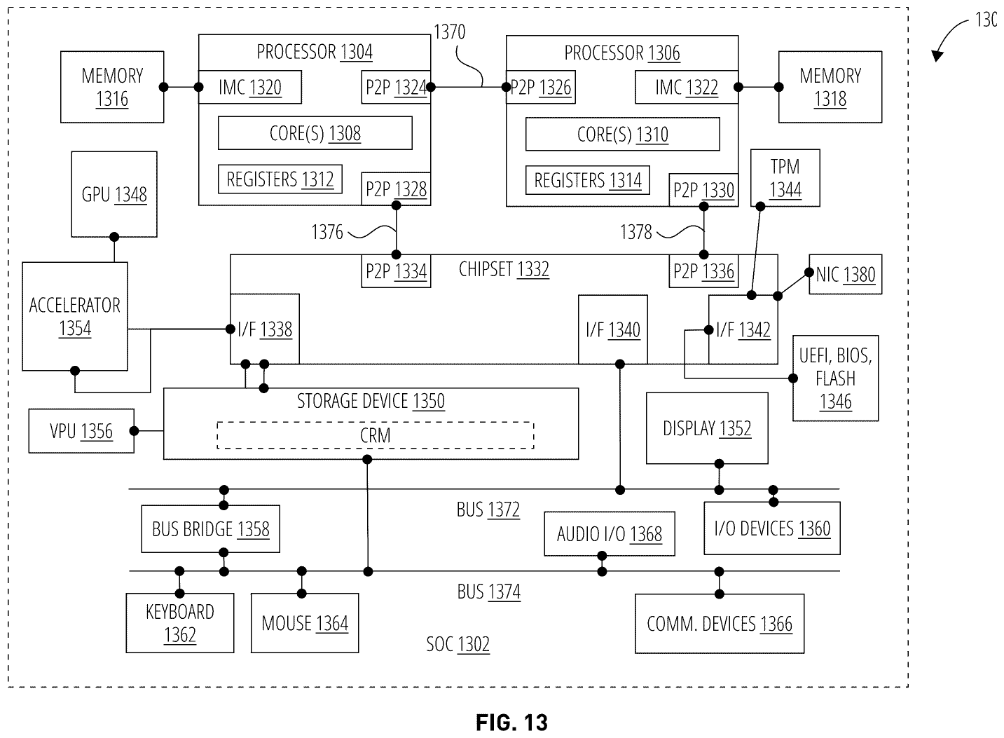

As depicted in FIG. 5, the inferencing device 504 includes processing circuitry 518, a memory 520, a storage medium 522, an interface 524, a platform component 526, ML logic 528, and an ML model 530. The ML model 530 is representative of the models 126. In some implementations, the inferencing device 504 includes other components or devices as well. Examples for software elements and hardware elements of the inferencing device 504 are described in more detail with reference to a computing architecture 1300 as depicted in FIG. 13. Embodiments are not limited to these examples.

The inferencing device 504 is generally arranged to receive an input 512, process the input 512 via one or more AI/ML techniques, and send an output 514. The inferencing device 504 receives the input 512 from the client device 502 via the network 508, the client device 506 via the network 510, the platform component 526 (e.g., a touchscreen as a text command or microphone as a voice command), the memory 520, the storage medium 522 or the data repository 516. The data repository 516 is representative of the data lake 116.

The inferencing device 504 sends the output 514 to the client device 502 via the network 508, the client device 506 via the network 510, the platform component 526 (e.g., a touchscreen to present text, graphic or video information or speaker to reproduce audio information), the memory 520, the storage medium 522 or the data repository 516. Embodiments are not limited to these examples.

The inferencing device 504 includes ML logic 528 and an ML model 530 to implement various AI/ML techniques for various AI/ML tasks. The ML logic 528 receives the input 512, and processes the input 512 using the ML model 530. The ML model 530 performs inferencing operations to generate an inference for a specific task from the input 512. In some cases, the inference is part of the output 514. The output 514 is used by the client device 502, the inferencing device 504, or the client device 506 to perform subsequent actions in response to the output 514.

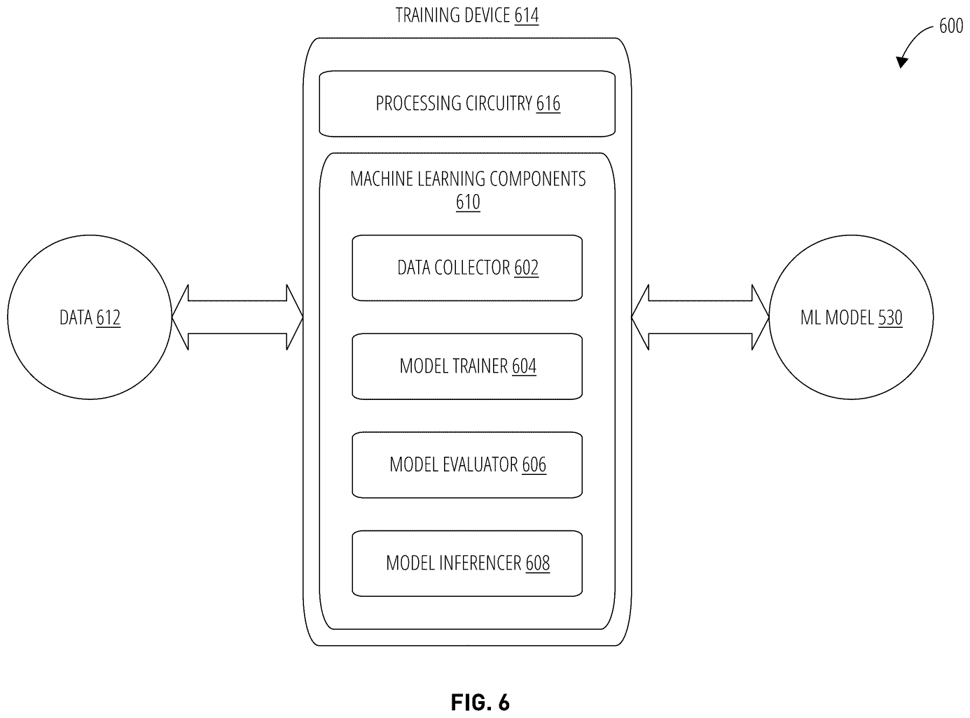

In various embodiments, the ML model 530 is a trained ML model 530 using a set of training operations. An example of training operations to train the ML model 530 is described with reference to FIG. 6.

FIG. 6 illustrates an apparatus 600. The apparatus 600 depicts a training device 614 suitable to generate a trained ML model 530 for the inferencing device 504 of the system 500. As depicted in FIG. 6, the training device 614 includes a processing circuitry 616 and a set of ML components 610 to support various AI/ML techniques, such as a data collector 602, a model trainer 604, a model evaluator 606 and a model inferencer 608.

In general, the data collector 602 collects data 612 from one or more data sources to use as training data for the ML model 530. The data collector 602 collects different types of data 612, such as text information, audio information, image information, video information, graphic information, and so forth. The data 612 includes the datasets 106, the dataset metadata 108, and the column metadata 110. The model trainer 604 receives as input the collected data and uses a portion of the collected data as test data for an AI/ML algorithm to train the ML model 530. The model evaluator 606 evaluates and improves the trained ML model 530 using a portion of the collected data as test data to test the ML model 530. The model evaluator 606 also uses feedback information from the deployed ML model 530. The model inferencer 608 implements the trained ML model 530 to receive as input new unseen data, generate one or more inferences on the new data, and output a result such as an alert, a recommendation or other post-solution activity.

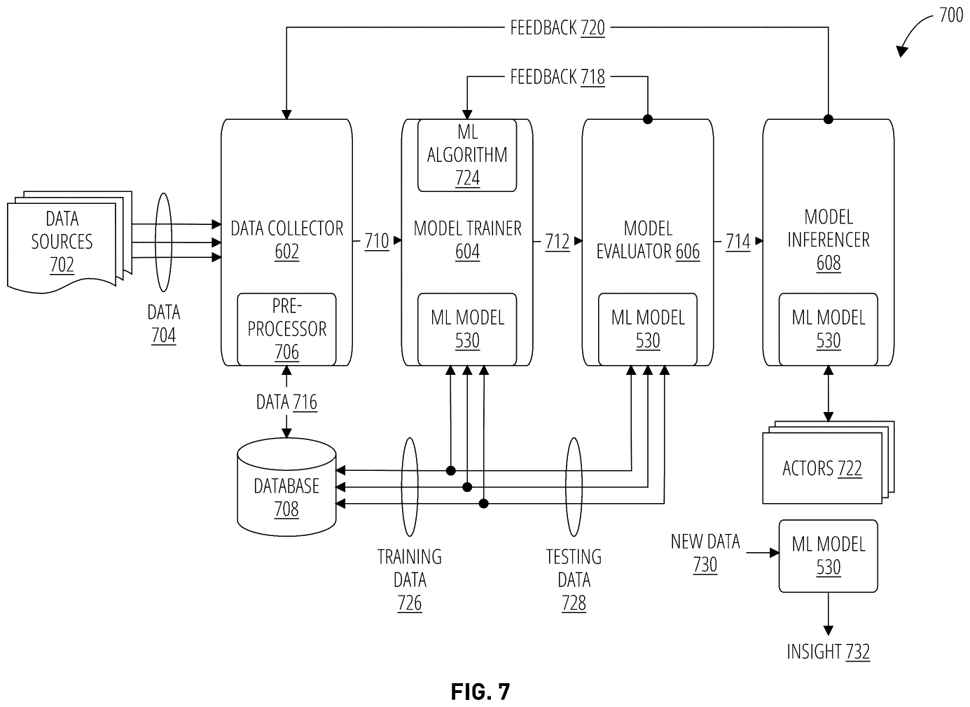

An exemplary AI/ML architecture for the ML components 610 is described in more detail with reference to FIG. 7.

FIG. 7 illustrates an artificial intelligence architecture 700 suitable for use by the training device 614 to generate the ML model 530 for deployment by the inferencing device 504. The artificial intelligence architecture 700 is an example of a system suitable for implementing various AI techniques and/or ML techniques to perform various inferencing tasks on behalf of the various devices of the system 500.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 700 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 530, evaluate performance of the trained ML model 530, and deploy the tested ML model 530 as the trained ML model 530 in a production environment, and continuously monitor and maintain it.

The ML model 530 is a mathematical construct used to predict outcomes based on a set of input data. The ML model 530 is trained using large volumes of training data 726, and it can recognize patterns and trends in the training data 726 to make accurate predictions. The ML model 530 is derived from an ML algorithm 724 (e.g., a neural network, decision tree, support vector machine, etc.). A data set is fed into the ML algorithm 724 which trains an ML model 530 to “learn” a function that produces mappings between a set of inputs and a set of outputs with a reasonably high accuracy. The data set used for training includes the data repository 516, including the datasets 106, dataset metadata 108, and/or the column metadata 110. Given a sufficiently large enough set of inputs and outputs, the ML algorithm 724 finds the function for a given task. This function may even be able to produce the correct output for input that it has not seen during training. A data scientist prepares the mappings, selects and tunes the ML algorithm 724, and evaluates the resulting model performance. Once the ML logic 528 is sufficiently accurate on test data, it can be deployed for production use.

The ML algorithm 724 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 724 of the artificial intelligence architecture 700 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 7, the artificial intelligence architecture 700 includes a set of data sources 702 to source data 704 for the artificial intelligence architecture 700. Data sources 702 may comprise any device capable generating, processing, storing or managing data 704 suitable for a ML system. Examples of data sources 702 include without limitation databases, web scraping, sensors and Internet of Things (IoT) devices, image and video cameras, audio devices, text generators, publicly available databases, private databases, and many other data sources 702. The data sources 702 may be remote from the artificial intelligence architecture 700 and accessed via a network, local to the artificial intelligence architecture 700 an accessed via a network interface, or may be a combination of local and remote data sources 702.

The data sources 702 source difference types of data 704. By way of example and not limitation, the data 704 includes structured data from relational databases, such as customer profiles, transaction histories, or product inventories. The data 704 includes unstructured data from websites such as customer reviews, news articles, social media posts, or product specifications. The data 704 includes data from temperature sensors, motion detectors, and smart home appliances. The data 704 includes image data from medical images, security footage, or satellite images. The data 704 includes audio data from speech recognition, music recognition, or call centers. The data 704 includes text data from emails, chat logs, customer feedback, news articles or social media posts. The data 704 includes publicly available datasets such as those from government agencies, academic institutions, or research organizations. The data 704 includes the datasets 106, dataset metadata 108, and column metadata 110. These are just a few examples of the many sources of data that can be used for ML systems. It is important to note that the quality and quantity of the data is critical for the success of a machine learning project.

The data 704 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 702 are communicatively coupled to a data collector 602. The data collector 602 gathers relevant data 704 from the data sources 702. Once collected, the data collector 602 may use a pre-processor 706 to make the data 704 suitable for analysis. This involves data cleaning, transformation, and feature engineering. Data preprocessing is a critical step in ML as it directly impacts the accuracy and effectiveness of the ML model 530. The pre-processor 706 receives the data 704 as input, processes the data 704, and outputs pre-processed data 716 for storage in a database 708. Examples for the database 708 includes a hard drive, solid state storage, and/or random access memory (RAM).

The data collector 602 is communicatively coupled to a model trainer 604. The model trainer 604 performs AI/ML model training, validation, and testing which may generate model performance metrics as part of the model testing procedure. The model trainer 604 receives the pre-processed data 716 as input 710 or via the database 708. The model trainer 604 implements a suitable ML algorithm 724 to train an ML model 530 on a set of training data 726 from the pre-processed data 716. The training process involves feeding the pre-processed data 716 into the ML algorithm 724 to produce or optimize an ML model 530. The training process adjusts its parameters until it achieves an initial level of satisfactory performance.

The model trainer 604 is communicatively coupled to a model evaluator 606. After an ML model 530 is trained, the ML model 530 needs to be evaluated to assess its performance. This is done using various metrics such as accuracy, precision, recall, and FI score. The model trainer 604 outputs the ML model 530, which is received as input 710 or from the database 708. The model evaluator 606 receives the ML model 530 as input 712, and it initiates an evaluation process to measure performance of the ML model 530. The evaluation process includes providing feedback 718 to the model trainer 604. The model trainer 604 re-trains the ML model 530 to improve performance in an iterative manner.

The model evaluator 606 is communicatively coupled to a model inferencer 608. The model inferencer 608 provides AI/ML model inference output (e.g., inferences, predictions or decisions). Once the ML model 530 is trained and evaluated, it is deployed in a production environment where it is used to make predictions on new data. The model inferencer 608 receives the evaluated ML model 530 as input 714. The model inferencer 608 uses the evaluated ML model 530 to produce insights or predictions on real data, which is deployed as a final production ML model 530. The inference output of the ML model 530 is use case specific. The model inferencer 608 also performs model monitoring and maintenance, which involves continuously monitoring performance of the ML model 530 in the production environment and making any necessary updates or modifications to maintain its accuracy and effectiveness. The model inferencer 608 provides feedback 718 to the data collector 602 to train or re-train the ML model 530. The feedback 718 includes model performance feedback information, which is used for monitoring and improving performance of the ML model 530.

Some or all of the model inferencer 608 is implemented by various actors 722 in the artificial intelligence architecture 700, including the ML model 530 of the inferencing device 504, for example. The actors 722 use the deployed ML model 530 on new data to make inferences or predictions for a given task, and output an insight 732. The actors 722 implement the model inferencer 608 locally, or remotely receives outputs from the model inferencer 608 in a distributed computing manner. The actors 722 trigger actions directed to other entities or to itself. The actors 722 provide feedback 720 to the data collector 602 via the model inferencer 608. The feedback 720 comprise data needed to derive training data, inference data or to monitor the performance of the ML model 530 and its impact to the network through updating of key performance indicators (KPIs) and performance counters.

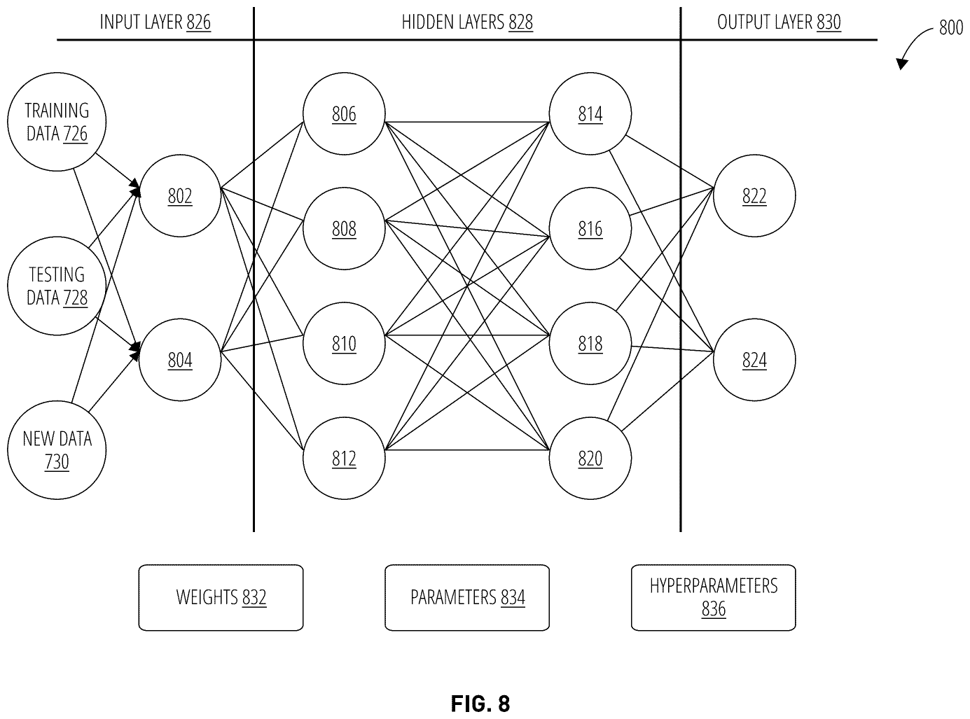

As previously described, the systems 500, 600 implement some or all of the artificial intelligence architecture 700 to support various use cases and solutions for various AI/ML tasks. In various embodiments, the training device 614 of the apparatus 600 uses the artificial intelligence architecture 700 to generate and train the ML model 530 for use by the inferencing device 504 for the system 500. In one embodiment, for example, the training device 614 may train the ML model 530 as a neural network, as described in more detail with reference to FIG. 8. Other use cases and solutions for AI/ML are possible as well, and embodiments are not limited in this context.

FIG. 8 illustrates an embodiment of an artificial neural network 800. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 800 comprises multiple node layers, containing an input layer 826, one or more hidden layers 828, and an output layer 830. Each layer comprises one or more nodes, such as nodes 802 to 824. As depicted in FIG. 8, for example, the input layer 826 has nodes 802, 804. The artificial neural network 800 has two hidden layers 828, with a first hidden layer having nodes 806, 808, 810 and 812, and a second hidden layer having nodes 814, 816, 818 and 820. The artificial neural network 800 has an output layer 830 with nodes 822, 824. Each node 802 to 824 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 800 relies on training data 726 to learn and improve accuracy over time. However, once the artificial neural network 800 is fine-tuned for accuracy, and tested on testing data 728, the artificial neural network 800 is ready to classify and cluster new data 730 at a high velocity. Tasks in speech recognition or image recognition can take minutes versus hours when compared to the manual identification by human experts.

Each individual node 802 to 424 is a linear regression model, composed of input data, weights, a bias (or threshold), and an output. The linear regression model may have a formula similar to Equation (1), as follows:

$$\sum wixi + bias = w 1 x 1 + w 2 x 2 + w 3 x 3 + bias \qquad Equation ( 1 )$$

$$output = f ( x ) = 1 if \sum w 1 x 1 + b >= 0 ; 0 if \sum w 1 x 1 + b < 0$$

Once an input layer 826 is determined, a set of weights 832 are assigned. The weights 832 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 800 as a feedforward network.

In one embodiment, the artificial neural network 800 leverages sigmoid neurons, which are distinguished by having values between 0 and 1. Since the artificial neural network 800 behaves similarly to a decision tree, cascading data from one node to another, having x values between 0 and 1 will reduce the impact of any given change of a single variable on the output of any given node, and subsequently, the output of the artificial neural network 800.

The artificial neural network 800 has many practical use cases, like image recognition, speech recognition, text recognition or classification. The artificial neural network 800 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = MSE = \frac{1}{2 m} {\sum }_{i = 1}^{m} {( \hat{{y}_{i}} - {y}_{i} )}^{2} \to MIN \qquad Equation ( 2 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 834 of the model adjust to gradually converge at the minimum.

In one embodiment, the artificial neural network 800 is feedforward, meaning it flows in one direction only, from input to output. In one embodiment, the artificial neural network 800 uses backpropagation. Backpropagation is when the artificial neural network 800 moves in the opposite direction from output to input. Backpropagation allows calculation and attribution of errors associated with each neuron 802 to 824, thereby allowing adjustment to fit the parameters 834 of the ML model 530 appropriately.

The artificial neural network 800 is implemented as different neural networks depending on a given task. Neural networks are classified into different types, which are used for different purposes. In one embodiment, the artificial neural network 800 is implemented as a feedforward neural network, or multi-layer perceptrons (MLPs), comprised of an input layer 826, hidden layers 828, and an output layer 830. While these neural networks are also commonly referred to as MLPs, they are actually comprised of sigmoid neurons, not perceptrons, as most real-world problems are nonlinear. Trained data 704 usually is fed into these models to train them, and they are the foundation for computer vision, natural language processing, and other neural networks. In one embodiment, the artificial neural network 800 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 800 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 800 is implemented as any type of neural network suitable for a given operational task of system 500, and the MLP, CNN, and RNN are merely a few examples. Embodiments are not limited in this context.

The artificial neural network 800 includes a set of associated parameters 834. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 800 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 836. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

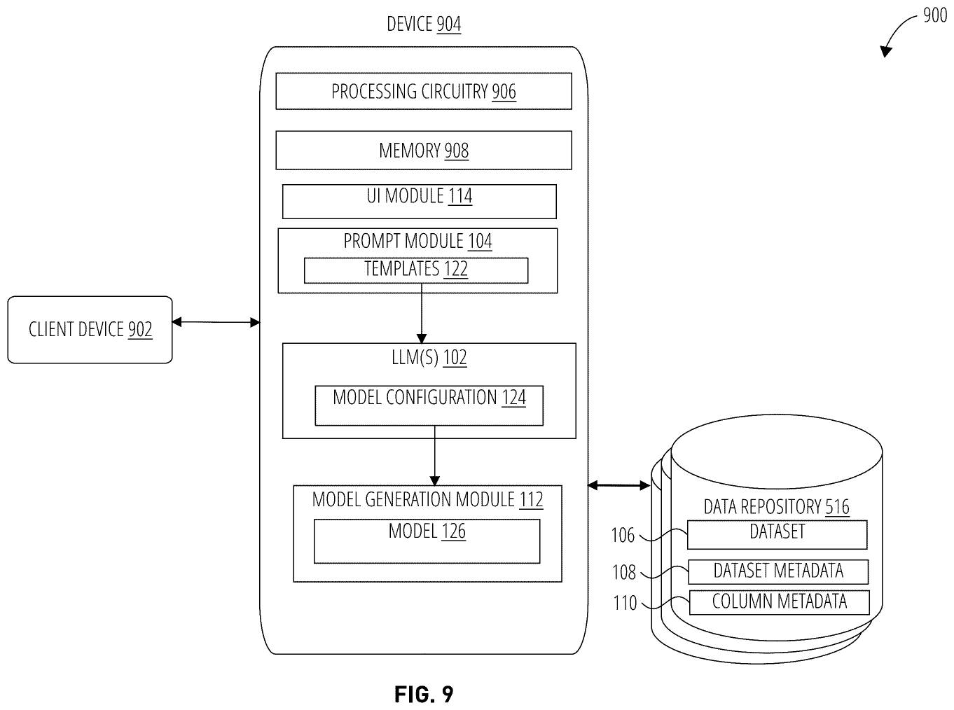

FIG. 9 illustrates an embodiment of a system 900. The system 900 is suitable for implementing one or more embodiments as described herein. In one embodiment, for example, the system 900 is an automated ML system suitable for generating propensity models using natural language statements.

The system 900 comprises a set of M devices, where M is any positive integer. FIG. 9 depicts two devices (M=2), including a client device 902 and a device 904. The device 904 is representative of the inferencing device 504. As depicted in FIG. 9, the device 904 includes processing circuitry 906, a memory 908, one or more of the UI modules 114, one or more of the prompt modules 104, one or more of the LLMs 102, and one or more of the model generation module 112.

As stated, the UI module 114 is configured to receive natural language input such as input 118, e.g., from the client device 902, where the natural language input specifies to create a ML model for a prediction goal. The UI module 114 may then parse the natural language input, and provide the parsed natural language input to the prompt module 104 and/or the LLM 102.

As stated, the prompt modules 104 use one or more templates 122 for providing information to the LLMs 102 to create a model configuration 124 for the model requested by the user. For example, the prompt modules 104 use the parsed natural language input to identify relevant datasets 106 based on the dataset metadata 108. The prompt modules 104 further use the column metadata 110 to identify one or more columns in the one or more datasets 106. The prompt modules 104 further generate descriptive metadata for the model to be created. The prompt modules 104 then fill in the variable metadata into the one or more template 122. Doing so allows the LLMs 102 to create a model configuration 124.

One example of a schema for the dataset metadata 108 is presented in Table I below:

TABLE I

| Field name | Data type | Value description |
|---|---|---|
| dataset_id | string | Any alpha-numeric |
| | | string that uniquely |
| | | identifies a dataset |
| dataset_name | string | Standard name of the |
| | | dataset |
| description | string | Description of the data |
| | | content |
| business_significance | string | The business context of |
| | | this dataset in the client's |
| | | organization |
| applies_to | string | The set of user types |
| | | and are described by |
| | | this data |
| available_identity | string | The columns in this |
| | | dataset that can be used |
| | | as user ID |

Similarly, one example of a schema for the column metadata 110 is presented in Table II below:

TABLE II

| | Data | |
|---|---|---|
| Field name | type | Value description |
| column_name | string | Standard column name, to be used in the |
| | | configuration expression |
| short_description | string | Common column name, used by the clients |
| long_description | string | Description of the column |
| description_of_{—} | string | The possible values the data column can |
| possible_values | | take. Can be a list or a recognized standard |
| | | (such as ISO standards). Optional: The |
| | | business meaning of each possible value. |

In some embodiments, the dataset metadata 108 and/or the column metadata 110 includes metadata associated with operators. An example metadata for the “equal” operator is: “{{“operator”:“eq”, “description”:“equal to”}}”. An example metadata for the “not in” operator is: “{{“operator”:“not_in”, “description”:“not equal to any one of the values in the following list”}}.”

As stated, in some embodiments, the dataset metadata 108 and the column metadata 110 for a request are fed into the LLM 102 as part of a CoT prompt. In some embodiments, the CoT prompt is performed using one or more of the templates 122. As stated, the prompt modules 104 may be implemented as an LLM 102, therefore, the CoT prompt templates 122 include instructions for operations performed by the prompt modules 104. Using CoT prompt 122 allows the LLM 102 to transform the prediction objective and suitable conditions into a sequence of logical expressions that can be applied to the machine learning dataset, e.g., as part of a model configuration 124. For example, the CoT prompt templates 122 guide the LLM 102 through a series of operations including translation of the user's natural language goal into data language. Doing so includes decomposing the natural language goal into a verb and an object. For example, if the input 118 includes “buy acro with Dubai money,” the decomposition includes identifying “buy” as the verb and “acro” as the object. Thereafter, the CoT prompt templates 122 are completed using the output from the prompt module 104 identifying column metadata 110 associated with the verb and/or the object. In some embodiments, the verb and/or object is used to search the column metadata 110 to identify one or more columns having metadata matching the verb and/or the object. The completed CoT prompt templates 122 further instruct the LLM 102 to associate various metadata fields in the column metadata 110 with one or more variable fields in the template. In embodiments where the column metadata 110 is a vector database, the LLM 102 accesses an embedding vector for the verb and/or object, and use the embeddings to search the column metadata 110. The embedding vector may be computed by any suitable component, such as the prompt module 104 and/or an embedding model. The CoT prompt templates 122 further instruct the LLM 102 to create a list of logical expressions, where each element is composed of: (i) a column name, which can only be one of the matching column names from the column metadata 110 (ii) an operator, (iii) a value that is allowed by the “description_of_possible_values” of the matched column in the column metadata 110, and under the constraint that the set of logical expressions need to retain the semantic meaning of the original input, as referenced by the column metadata 110 and the operator metadata.

As stated, the model generation module 112 operates on one or more restrictive syntaxes and/or expressions. Advantageously, the logical expressions created by the LLM 102 translate the natural language input into the correct syntax and/or expression. Doing so allows models to be created without knowledge of the datasets 106 and components thereof. This is particularly useful when the natural language input includes typos, non-standard language, or irrelevant information.

Continuing with the “buy acro” example natural language input, logical expressions (which correspond to a portion of the model configuration 124) created by the LLM 102 include: “[{{‘column_name’:‘commerce.purchases’, ‘operator’: ‘gt’, ‘value’: 0}}, {{‘column_name’:‘_experience.analytics.customDimensions.props.prop2’, ‘operator’: ‘eq’, ‘value’: ‘acrobat’}}, {{‘column_name’:‘commerce.order.currencyCode’, ‘operator’: ‘eq’, ‘value’: ‘AED’}}]”. Therefore, for example, the LLM 102 converts the term “buy acro” to specific column names and other associated data in the syntax required by the model generation module 112. As stated, at least a portion of the model configuration 124 is based on converting the term “buy acro” into the required syntax.

Advantageously, the LLM 102 is sophisticated enough to associate a column's name with its business context and link a standard product's name with the product's functionality. Furthermore, the LLM 102 is able to identify irrelevant requests. For example, a natural language goal of “buy kryptonite” returns a null statement or error, as this is not a valid prediction goal for the client.

As stated, in some embodiments, the column metadata 110 does not associate concepts explicitly. For example, the column metadata 110 for the “commerce.order.currency.currencyCode” column may not expressly relate “Dubai” to “AED”. However, the LLM 102 uses the column metadata 110 to learn an association between “Dubai” and “AED”. An example of the column metadata 110 for the “commerce.order.currency.currencyCode” column is:
{“column_name”: “commerce.order.currencyCode”, “short_description”: “currency code”, “long_description”: “currency code defined by the international standard ISO 4217”, “description_of_possible_values”: “The value is always alphabetic code of length 3. The first two letter is identical to the ISO 3166 country code of the country where the currency is made, and, where possible, the third letter corresponds to the first letter of the currency name. For example: The US dollar is represented as ‘USD’—the US coming from the ISO 3166 country code and the D for dollar. The Swiss franc is represented by CHF—the CH being the code for Switzerland in the ISO 3166 code and F for franc.”}

Therefore, the LLM 102 understands ISO standard facilitated by the translation process, eliminating the need for users to supply a comprehensive country code table as metadata. Embodiments are not limited in these contexts, as the LLMs 102 are configured to learn other types of associations.

In some embodiments, one or more functions that employ one or more LLMs 102 are defined. For example, a “get_model_name” function returns a model name based on input parameters. As another example, a “get_model_type” function returns a model type (e.g., conversion model, churn model, etc.) based on a prediction goal provided as input. As another example, a “get_model_description” function generates a concise summary of the model for documentation purposes, thereby facilitating model search and query operations. As yet another example, a “get_dataset_selection” function returns one or more datasets 106 that are tailored to the ML objectives specified by the users. In some embodiments, the datasets 106 selected are determined based at least in part on the dataset metadata 108. As another example, a “get_id_type” function returns an identity column from one or more datasets 106, e.g., the dataset 106 returned by the “get_dataset_selection” function. In some embodiments, the identity column is determined based at least in part on the customer type and dataset metadata 108. An example “n12config” function converts the prediction goal and eligible conditions into the sequence of logical expressions described above using CoT prompting. A comprehensive array of suggested model configuration 124 is provided to the client for validation (e.g., via the interface 400). The user may then submit the job for model creation by the model generation module 112. In some embodiments, the model generation module 112 returns an indication that one or more models 126 have been generated. The one or more models 126 are stored in any accessible storage location, e.g., memory 908, data lake 116, etc.

As stated, in some embodiments, retrieval-augmented generation (RAG) is used to condense the metadata provided to an LLM 102 during the CoT prompt, e.g., when the sequence length limit of the LLM 102 poses constraints. In some embodiments, one or more of the LLMs 102 are leveraged for zero-shot or few-shot prompts to execute auxiliary tasks, such as model naming, model description creation, model type identification, and validation/evaluation.

More generally, once the LLM 102 creates the model configuration 124, the model configuration 124 is provided to the model generation module 112 to create (e.g., train, test, and/or validate) one or more models 126 as responsive to the user's natural language request. Embodiments are not limited in these contexts.

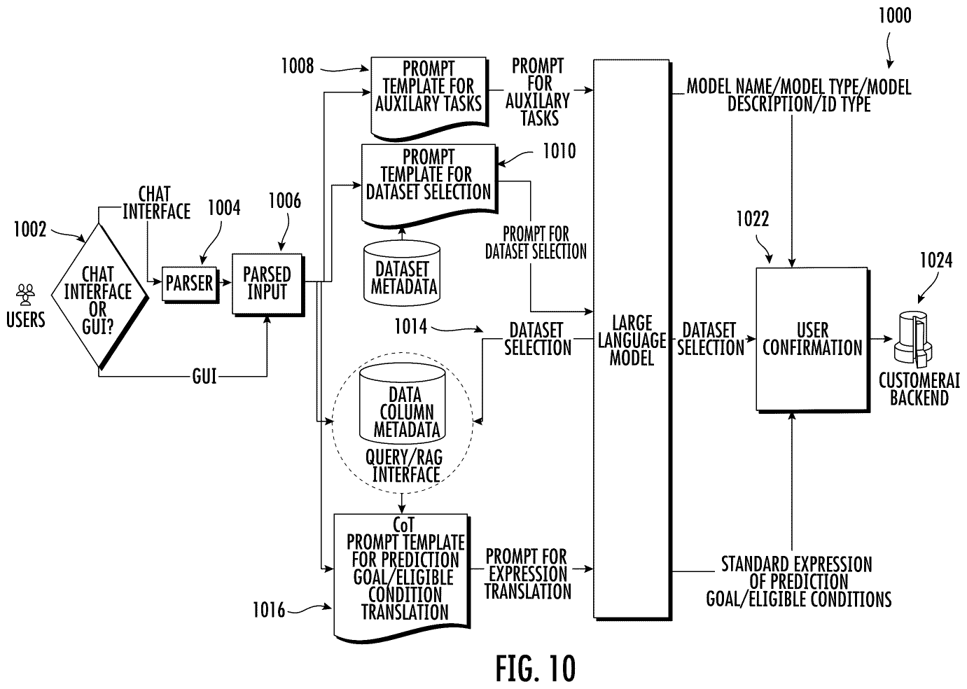

FIG. 10 illustrates an embodiment of a flow diagram 1000 for generating propensity models using natural language statements. The flow diagram 1000 includes some or all of the operations performed by devices or entities in the system 100, system 500, and/or system 900. Embodiments are not limited in these contexts.

At block 1002, user input is received via a GUI, such as chatbot interface 332, interface 300, or interface 320. The user input is natural language input for creating a model. If the GUI is a chatbot interface 332, the flow diagram 1000 proceeds to block 1004, where a parser function parses the user input. For example, the parser function returns one or more conditions, one or more prediction goals, one or more customer types, one or more eligibility windows, and one or more outcome windows. Returning to block 1002, the GUIs 300, 320, provide such parsed input, so the flow diagram 1000 proceeds to block 1006. At block 1006, the parsed input is provided to the LLMs 102 via a variety of functions.

For example, at block 1008, the prompt module 104 is used to complete a prompt template 122 from the template 122 for auxiliary tasks. Auxiliary tasks include generating a name for the model (e.g., model name field 402), a description for the model (e.g., model description field 404), a model type of the model (e.g., model type field 406), etc. The completed prompt template 122 (e.g., the template with variable values inserted) is provided to the LLMs 102 for further processing.

An example of a template 122 for auxiliary tasks includes a natural language statement of the objective, e.g., listen to a request and return a specific set of results. The specific set of results include the prediction goal, outcome time window, customer type, eligibility conditions/constraints, and/or eligibility time windows. The specific sets of results includes descriptions thereof and possible values. The template 122 for auxiliary tasks further includes one or more example questions with answers. The template 122 further includes a template for a question to be answered by the LLMs 102, where the template includes variable fields, e.g., the specific natural language prompt, etc. The LLMs 102 determine values for the variable fields and insert the values into the variable fields in the templates 122.

At block 1010, the prompt module 104 uses a template 122 for selection of one or more of the datasets 106 based on the dataset metadata 108. For example, the prompt module 104 searches the dataset metadata 108 based on one or more terms in the parsed input. As stated, in some embodiments, the prompt module 104 uses a query/RAG interface to the column metadata 110. As another example, the prompt module 104 generates an embedding vector for one or more terms in the parsed input and searches the dataset metadata 108 based on the vector. The prompt module 104 then processes results from the dataset metadata 108, e.g., one or more candidate datasets from the datasets 106. For example, the prompt module 104 uses the dataset metadata 108 to determine values associated with the relevant datasets in the schema (see Table I for an example schema). The prompt module 104 completes a dataset selection prompt template from the templates 122 using the received information (e.g., by filling in variables in the template 122 with received data) and provides the dataset selection prompt template to one of the LLMs 102 for further processing.

An example of a template 122 for dataset selection includes a natural language statement of the objective, e.g., return one or more of the datasets 106. The template 122 for dataset selection further includes one or more example questions for dataset selection with answers. The template 122 for dataset selection further includes a template for a question to be answered by the LLMs 102, where the template includes variable fields, e.g., for the dataset descriptions, the conditions, prediction goal, etc.

At block 1016, a CoT prompt template 122 is used to convert the parsed input into compatible expression for one or more goals and one or more conditions. As shown, the procedure to complete the CoT prompt template includes querying the column metadata 110 to receive metadata for one or more columns. In some embodiments, the interface between the prompt module 104 and the column metadata 110 is a RAG interface. As depicted by block 1014, the datasets 106 selected based on block 1010 are used to influence the selection of column metadata 110. For example, if a column is not included in the selected dataset 106, the column metadata 110 for this column is not returned at block 1016.

An example of a CoT template 122 from the templates 122 for the CoT operation is summarized. Generally, the CoT template 122 includes natural language which describes the overall CoT process to the LLMs 102, e.g., translate a prediction goal in natural language into one or more JSON objects composed of a column_name, an operator, and a value. The template 122 indicates that the dataset metadata 108 and/or the column metadata 110 are stored in JSON format and describes the associated schemas (e.g., the schemas described in Table I or Table II). Furthermore, the CoT template 122 includes high-level natural language describing the dataset 106 and the more detailed description of the individual data columns. Such natural language includes synonyms, possible values, operator definitions, etc. The CoT template 122 further includes example questions and answers to guide the LLMs 102 in creating a correct answer to the example questions. The CoT template 122 then includes a request to translate the user input according to the defined examples. Embodiments are not limited in these contexts.

The completed CoT prompt template 122 is then provided to the LLMs 102 for further processing, e.g., to create the model configuration 124 based on the auxiliary task template 122, dataset selection template 122, and the CoT prompt template 122. For example, the model configuration 124 includes the identification of some or all of the data depicted in FIG. 4. At block 1022, the model configuration 124 is returned to the user for approval. If the user approves, the model configuration 124 is provided to the model generation module 112 at block 1024, which creates one or more models 126, which include propensity models. Embodiments are not limited in these contexts.

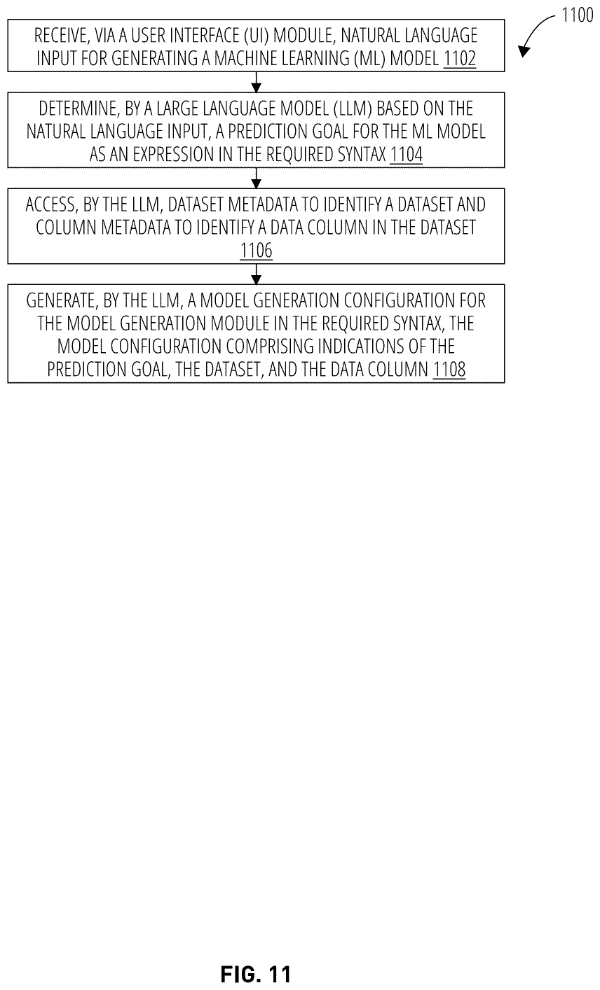

FIG. 11 illustrates an embodiment of a logic flow 1100. The logic flow 1100 is representative of some or all of the operations executed by one or more embodiments described herein. For example, the logic flow 1100 includes some or all of the operations performed by devices or entities in the system 500 and/or system 900 to generate propensity models using natural language statements. Embodiments are not limited in these contexts.

In block 1102, logic flow 1100 receives, via a user interface (UI) module such as UI module 114, natural language input for generating a machine learning (ML) model. In block 1104, logic flow 1100 determines, by a large language model (LLM) such as LLM 102 or prompt module 104 based on the natural language input, a prediction goal as an expression in the required syntax for the model generation module 112. In block 1106, logic flow 1100 accesses, by the LLM, dataset metadata 108 to identify one or more dataset 106 and column metadata 110 to identify one or more data columns in the dataset. In block 1108, logic flow 1100 generates, by the LLM 102, a model generation configuration (e.g., model configuration 124) with the syntax required by the model generation module 112. As stated, the model configuration indicates the prediction goal, the dataset, and the data column.

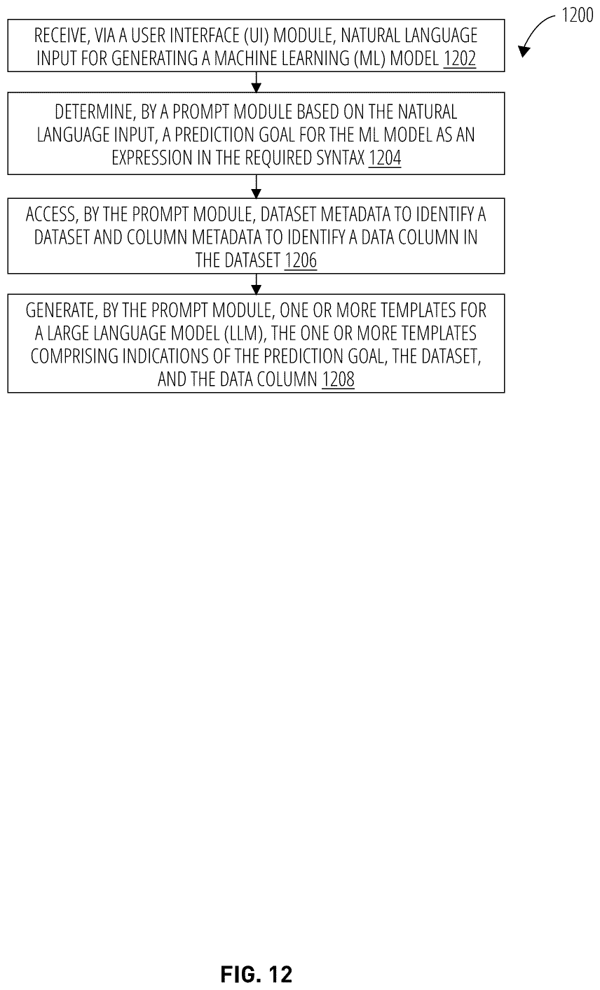

FIG. 12 illustrates an embodiment of a logic flow 1200. The logic flow 1200 is representative of some or all of the operations executed by one or more embodiments described herein. For example, the logic flow 1200 includes some or all of the operations performed by devices or entities in the system 500 and/or system 900 to generate propensity models using natural language statements. Embodiments are not limited in these contexts.

In block 1202, logic flow 1200 receives, via a user interface (UI) module such as UI module 114, natural language input for generating a machine learning (ML) model. In block 1204, logic flow 1200 determines, by a prompt module such as prompt module 104 based on the natural language input, a prediction goal in the required syntax for the model generation module 112 to generate the ML model. In block 1206, logic flow 1200 accesses, by the prompt module, dataset metadata 108 to identify one or more datasets 106 and column metadata 110 to identify one or more data columns in the one or more datasets 106. In block 1208, logic flow 1200 generates, by the prompt module, one or more templates for a large language model (LLM), the one or more templates comprising indications of the prediction goal, the dataset, and the data column.

FIG. 13 illustrates an embodiment of a computing architecture 1300. Computing architecture 1300 is a computer system with multiple processor cores such as a distributed computing system, supercomputer, high-performance computing system, computing cluster, mainframe computer, client-server system, personal computer (PC), workstation, server, or other device for processing, displaying, or transmitting information. Similar embodiments may comprise, e.g., devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1300 has a single processor with one core or more than one processor. Note that the term “processor” refers to a processor with a single core or a processor package with multiple processor cores. In at least one embodiment, the computing architecture 1300 is representative of the components of the system 500 and/or system 900. More generally, the computing architecture 1300 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1300. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 13, computing architecture 1300 comprises a system-on-chip (SoC) 1302 for mounting platform components. System-on-chip (SoC) 1302 is a point-to-point (P2P) interconnect platform that includes a first processor 1304 and a second processor 1306 coupled via a point-to-point interconnect 1370. Furthermore, each of processor 1304 and processor 1306 are processor packages with multiple processor cores including core(s) 1308 and core(s) 1310, respectively.

The processor 1304 and processor 1306 are any commercially available processors. Additionally, the processor 1304 need not be identical to processor 1306.

Processor 1304 includes an integrated memory controller (IMC) 1320 and point-to-point (P2P) interface 1324 and P2P interface 1328. Similarly, the processor 1306 includes an IMC 1322 as well as P2P interface 1326 and P2P interface 1330. IMC 1320 and IMC 1322 couple the processor 1304 and processor 1306, respectively, to respective memories (e.g., memory 1316 and memory 1318). Memory 1316 and memory 1318 are portions of the main memory (e.g., a dynamic random-access memory (DRAM)) for the platform such as double data rate type 4 (DDR4) or type 5 (DDR5) synchronous DRAM (SDRAM). Processor 1304 includes registers 1312 and processor 1306 includes registers 1314.

Computing architecture 1300 includes chipset 1332 coupled to processor 1304 and processor 1306. Furthermore, chipset 1332 are coupled to storage device 1350, for example, via an interface (I/F) 1338. The I/F 1338 may be, for example, a Peripheral Component Interconnect-enhanced (PCIe) interface, etc. Storage device 1350 stores instructions executable by circuitry of computing architecture 1300. For example, storage device 1350 can store instructions for the client device 502, the client device 506, the inferencing device 504, the training device 614, client device 902, device 904, or the like.

Processor 1304 couples to the chipset 1332 via P2P interface 1328 and P2P 1334 while processor 1306 couples to the chipset 1332 via P2P interface 1330 and P2P 1336. Direct media interface (DMI) 1376 and DMI 1378 couple the P2P interface 1328 and the P2P 1334 and the P2P interface 1330 and P2P 1336, respectively.

The chipset 1332 comprises a controller hub such as a platform controller hub (PCH). In the depicted example, chipset 1332 couples with a trusted platform module (TPM) 1344 and UEFI, BIOS, FLASH circuitry 1346 via I/F 1342. The TPM 1344 is a dedicated microcontroller designed to secure hardware by integrating cryptographic keys into devices. The UEFI, BIOS, FLASH circuitry 1346 may provide pre-boot code. The I/F 1342 may also be coupled to a network interface circuit (NIC) 1380 for connections off-chip.

Furthermore, chipset 1332 includes the I/F 1338 to couple chipset 1332 with a high-performance graphics engine, such as, graphics processing circuitry or a graphics processing unit (GPU) 1348.

The computing architecture 1300 is operable to communicate with wired and wireless devices or entities via the network interface (NIC) 1380 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1354 and/or vision processing unit 1356 are coupled to chipset 1332 via I/F 1338. The accelerator 1354 is representative of any type of accelerator device and includes circuitry arranged to execute machine learning (ML) related operations (e.g., training, inference, etc.) for ML models. Generally, the accelerator 1354 is specially designed to perform computationally intensive operations, such as hash value computations, comparison operations, cryptographic operations, and/or compression operations, in a manner that is more efficient than when performed by the processor 1304 or processor 1306. Because the load of the computing architecture 1300 includes hash value computations, comparison operations, cryptographic operations, and/or compression operations, the accelerator 1354 greatly increases performance of the computing architecture 1300 for these operations.

Various I/O devices 1360 and display 1352 couple to the bus 1372, along with a bus bridge 1358 which couples the bus 1372 to a second bus 1374 and an I/F 1340 that connects the bus 1372 with the chipset 1332. In one embodiment, the second bus 1374 is a low pin count (LPC) bus. Various input/output (I/O) devices couple to the second bus 1374 including, for example, a keyboard 1362, a mouse 1364 and communication devices 1366.

Furthermore, an audio I/O 1368 couples to second bus 1374. Many of the I/O devices 1360 and communication devices 1366 reside on the system-on-chip (SoC) 1302 while the keyboard 1362 and the mouse 1364 are add-on peripherals. In other embodiments, some or all the I/O devices 1360 and communication devices 1366 are add-on peripherals and do not reside on the system-on-chip (SoC) 1302.

The various elements of the devices as previously described with reference to the figures include various hardware elements, software elements, or a combination of both. Examples of hardware elements include devices, processors, microprocessors, circuits, and so forth. Examples of software elements include programs, applications, application programming interfaces (APIs), or any software.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), an Application Specific Integrated Circuit (ASIC), or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What is claimed is:

1. A method, comprising:
receiving, via a user interface (UI) module, natural language input for generating a machine learning (ML) model;
determining, by a large language model (LLM) based on the natural language input, a prediction goal for the ML model;
accessing, by the LLM, dataset metadata to identify a dataset and column metadata to identify a data column in the dataset; and
generating, by the LLM, a model configuration for the ML model based on a syntax, the model configuration comprising indications of the prediction goal, the dataset, and the data column.

2. The method of claim 1, wherein generating the model configuration comprises:
determining one or more attributes of the dataset based on the dataset metadata;
determining one or more attributes of the data column based on the column metadata; and
providing the one or more attributes of the data column and the one or more attributes of the dataset to a template.

3. The method of claim 1, wherein accessing the dataset metadata comprises:
accessing, by the LLM, an embedding vector, the embedding vector based on one or more terms associated with the prediction goal;
accessing, by the LLM, the dataset metadata based on the embedding vector; and
receiving, by the LLM, the dataset metadata associated with the dataset.

4. The method of claim 1, wherein the syntax is associated with a model generation module, the method further comprising:
transmitting, by the LLM to the model generation module, a request to generate the ML model based on the model configuration.

5. The method of claim 1, wherein determining the prediction goal comprises:
determining, by the LLM, one or more entities based on the natural language input; and
determining, by the LLM, the prediction goal based on the one or more entities.

6. The method of claim 3, wherein the data column is further identified based on the identification of the dataset.

7. The method of claim 1, further comprising:
generating, by the LLM, one or more attributes for the ML model based on the natural language input.

8. A system comprising:
a memory component; and
one or more processing devices coupled to the memory component, the one or more processing devices to perform operations comprising:
receiving, by a large language model (LLM), a prompt template from a prompt module;
determining, by the LLM based on the template, a prediction goal for a machine learning (ML) model;
accessing, by the LLM, dataset metadata to determine a dataset and column metadata to determine a data column in the dataset; and
instructing, by the LLM, a model generation module to generate the ML model based on a model configuration for the ML model, the model configuration comprising indications of the prediction goal, the dataset, and the data column.

9. The system of claim 8, wherein the template is based on natural language input specifying to generate the ML model.

10. The system of claim 8, wherein the model configuration is based on a syntax or an expression associated with the model generation module.

11. The system of claim 8, the one or more processing devices to perform operations comprising:
determining, by the LLM, one or more attributes of the dataset based on the dataset metadata;
determining, by the LLM, one or more attributes of the data column based on the column metadata; and
generating, by the LLM, the model configuration based on the one or more attributes of the data column and the one or more attributes of the dataset to a template.

12. The system of claim 8, the one or more processing devices to perform operations comprising:
determining, by the LLM based on the column metadata, one or more operators associated with the data column, wherein the model configuration comprises indications of the one or more operators.

13. The system of claim 8, the one or more processing devices to perform operations comprising:
determining, by the LLM based on the column metadata, one or more valid values associated with the data column, wherein the model configuration comprises an indication of at least one of the one or more valid values associated with the column.

14. The system of claim 8, the one or more processing devices to perform operations comprising:
accessing, by the LLM, an embedding vector generated based on one or more terms associated with the prediction goal;
accessing, by the LLM, the dataset metadata based on the embedding vector; and
receiving, by the LLM from the dataset metadata, the dataset metadata associated with the dataset.

15. A method, comprising:
receiving, via a user interface (UI) module, natural language input for generating a machine learning (ML) model;
determining, by a prompt module based on the natural language input, a prediction goal in a syntax for generating the ML model;
accessing, by the prompt module, dataset metadata to identify a dataset and column metadata to identify a data column in the dataset; and
generating, by the prompt module, one or more templates for a large language model (LLM), the one or more templates comprising indications of the prediction goal, the dataset, and the data column.

16. The method of claim 15, further comprising:
providing the one or more templates to the LLM for generation of a model configuration based on the one or more templates.

17. The method of claim 15, wherein generating the one or more templates comprises:
determining one or more attributes of the dataset based on the dataset metadata;
determining one or more attributes of the data column based on the column metadata; and
providing the one or more attributes of the data column and the one or more attributes of the dataset to at least one of the one or more templates.

18. The method of claim 15, wherein accessing the column metadata comprises:
computing, by the prompt module, an embedding based on one or more terms associated with the natural language input;
accessing, by the prompt module, the column metadata based on the embedding; and
receiving, by the prompt module based on the embedding, the column metadata associated with the data column.

19. The method of claim 15, wherein the prompt module comprises another LLM.

20. The method of claim 18, wherein the data column is further identified based on the dataset.
